(19) United States
(12) Patent Application Publication
(10) Pub. No.: US 2023/0334408 A1
(43) Pub. Date: Oct. 19, 2023

(54) TRAINING, ANALYSIS, AND COMMUNICATION SYSTEM FOR FINANCIAL PLANNING AND METHOD OF USE

(71) Applicant: LT3 Innovations, Inc, Overland Park, KS (US)

(72) Inventor: Timothy C Stiles, Olathe, KS (US)

(21) Appl. No.: 18/213,380

(22) Filed: Jun. 23, 2023

Related U.S. Application Data
(63) Continuation of application No. 17/498,302, filed on Oct. 11, 2021, now abandoned.
(60) Provisional application No. 63/089,804, filed on Oct. 9, 2020.

(51) Int. Cl. G06Q 10/0639; G06Q 40/06; G06Q 10/0631

(52) U.S. Cl. CPC G06Q 10/06398; G06Q 40/06; G06Q 10/063114

(57) ABSTRACT

A software application for use with mobile computing devices (e.g. smart phones and tablets) by financial planning experts in the field. The software application would be downloaded to the agent's computing device and will have constant communication to a remote server for processing and sending results to the expert's computing device. The expert will hand their computing device to the client who will then use the software application to input data relevant to their financial position. The central server will receive that data and send back alert results which will help to guide the discussion of financial planning.

### CROSS-REFERENCE TO RELATED APPLICATION

This application is a continuation of and claims priority in U.S. patent application Ser. No. 17/498,302, Filed Oct. 11, 2021, which claims priority in U.S. Provisional Patent Application No. 63/089,804 Filed Oct. 9, 2020, both of which are incorporated herein by reference.

### BACKGROUND OF THE INVENTION

### 1. Field of the Invention

The present invention relates generally to a system and method for training and evaluating financial professionals, and more specifically to a software application and associated methods of practice for training financial professionals while analyzing client financial planning needs, and communication elements thereof.

### 2. Description of the Related Art

The typical process for setting up financial planning for clients involves a financial planning expert asking the client many personal questions, many of which are irrelevant to that particular client, and many which the client may not feel comfortable discussing with others. Further, these discussions can take up a lot of time, which some clients may not be willing to sit through.

More issues with this particular industry lie in the daily tracking of a field sales force in the financial services industry. Many managers have no idea as to what their agents are doing on a daily basis while out in the field. There are systems in place to monitor phone calls and phone conversations while in house but nothing to monitor activity while the agents are actually out of the office and in the field meeting with people.

What is needed is a simple, fast way to determine what financial planning options are available to a client, while simultaneously providing communication of the client's data to the financial planning entity so that they can best determine how to serve the client. An additional bonus to such a system would be the ability to train financial professionals in real time using the system.

Heretofore there has not been available a system or method for a financial planning training, analysis, and communications system and method of use with the advantages and features of the present invention.

### BRIEF SUMMARY OF THE INVENTION

The present invention provides a software application for use with mobile computing devices (e.g. smart phones and tablets) by financial planning experts in the field. The software application would be downloaded to the agent's computing device and will have constant communication to a remote server for processing and sending results to the expert's computing device. The expert will hand their computing device to the client who will then use the software application to input data relevant to their financial position. The central server will receive that data and send back alert results which will help to guide the discussion of financial planning.

Through this communication tool, the field expert's data is collected at a central location for daily review and summary reports for their general manager. The manager will at a glance be able see what their agents did yesterday and the summary of bullet points that were covered in conversations while in the field. The manager will then inquiry as to how the agent handled the situation. The result is a program that allows immediate feedback and training from the supervisor to the field rep within 24 hours. In just a few minutes review the supervisor will know what was discussed and be able to train that rep on how best to help the client moving forward. Classroom training in all fields is inferior to what one may learn while actually practicing their trade. There is no personal information from the client that ties this data to them other than their initials. The data will be time stamped when it is gathered and the initials will allow the agent to recall who they were meeting with at that time to facilitate their training.

### BRIEF DESCRIPTION OF THE DRAWINGS

The drawings constitute a part of this specification and include exemplary embodiments of the present invention illustrating various objects and features thereof.

FIG. 1 is a diagrammatic representation of the performance of a financial advising task as it occurs in the state of the prior art.

FIG. 2 is a diagrammatic representation thereof showing an embodiment of the present invention being employed.

FIG. 3 is a diagrammatic representation of the elements utilized in practicing an embodiment of the present invention.

FIG. 4 is a diagrammatic representation of a user interface associated with an embodiment of the present invention.

FIG. 5 is another diagrammatic representation of a second user interface thereof.

FIG. 6 is a flowchart diagramming the steps taken in practicing the financial advising task of FIG. 1 in the state of the prior art.

FIG. 7 is a flowchart diagramming the steps taken in practicing the task shown in FIG. 2 as an embodiment of the present invention.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Additional examples include a mobile smart device including a display device for viewing a typical web browser or user interface will be commonly referred to throughout the following description. The type of device, computer, display, or user interface may vary when practicing an embodiment of the present invention. Drivers and couriers are the resources to be allocated using the present invention, and may often be used interchangeably, as may dealers and requestors. Said terminology will include the words specifically mentioned, derivatives thereof and words of similar meaning.

### II. Preferred Embodiment Financial Planning System 2

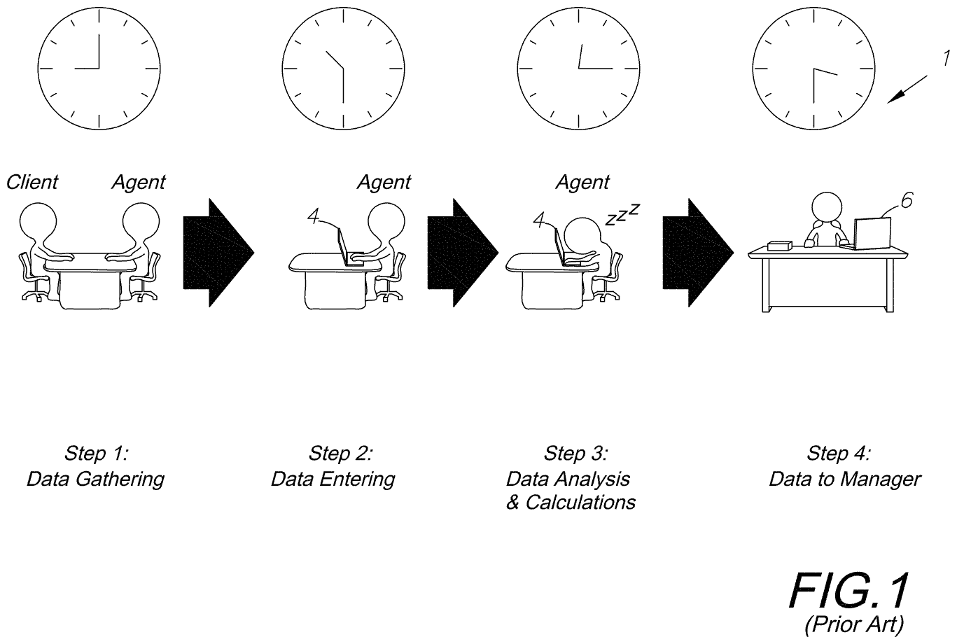

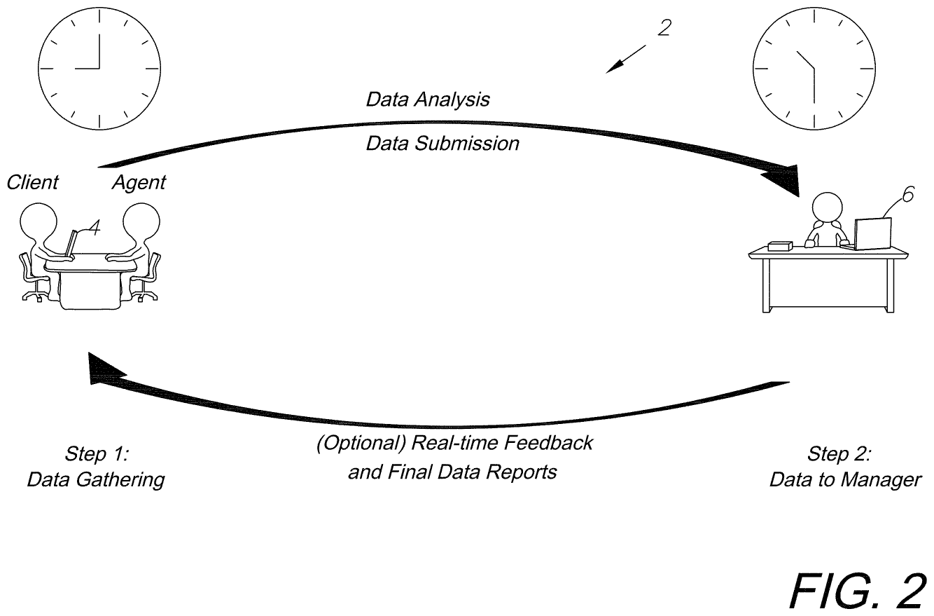

FIG. 1 shows the status of the current prior art financial planning systems 1. Data is generally gathered by an agent from the client through a discussion, the agent then enters the data into the agent's computing device 4 and analyzes it, which is time consuming. This process also has the increased risk of miscommunication of agent questions to clients or client responses to the agent. The collected data then is sent to the manager's computing device 6 who will decide how to act. FIG. 2 shows how the present financial planning system 2 would change the process currently employed and speed up the way data is provided to the manager, while reducing errors that may stem from the time it takes from the client-agent meeting to the time data is sent to the manager. This also can allow for real-time feedback from the manager to the agent in the field as data is concurrently received.

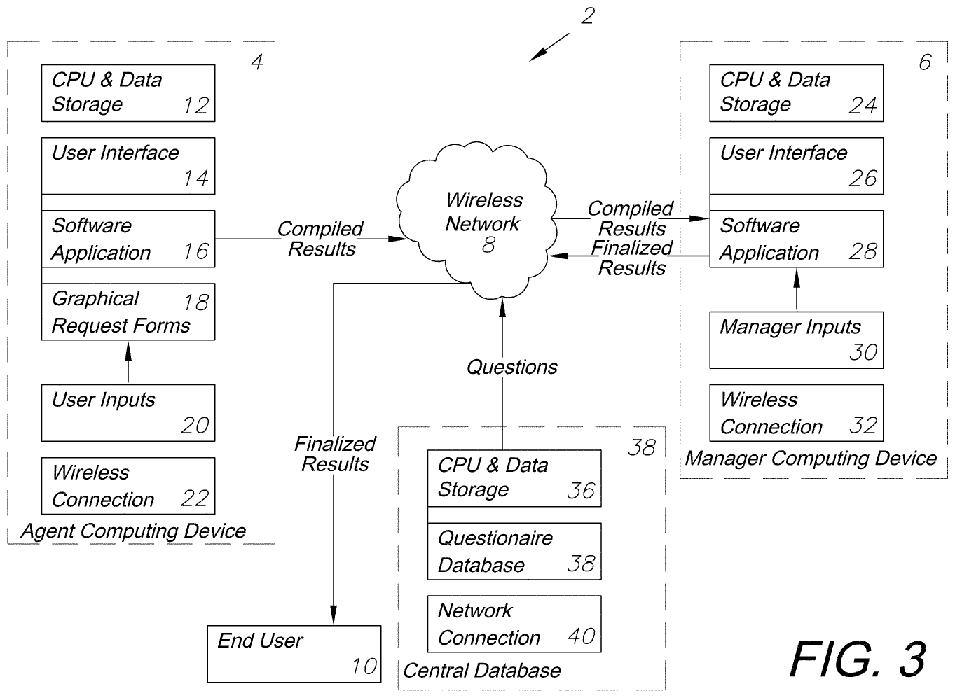

FIG. 3 diagrams the components of the present financial planning system 2. The agent's mobile computing device 4 would include preferably a tablet, laptop computer, or at least a smart phone. The agent's computing device 4 includes CPU & data storage 12, and a user interface 14 such as an interactive touch screen interface. A software application 16 stored on the data and operable by the CPU allows the client to provide responses to queries posed by the software application 16 using the user interface 14, such as by clicking boxes or entering information. Graphical request forms 18 are included in the software application 16 and are edited via the user interface 14 based upon user inputs 20. A wireless connection 22 allows the agent's computing device 4 to connect to a wireless network 8, such as the internet, to send and receive data.

Once compiled results are produced by the agent's computing device 4 software application 16, those results are sent through the wireless network 8 to the manager computing device 6, which also includes at least a CPU and data storage 24 and a user interface 26. A software application 28 receives the compiled results from the agents computing device 4 and allows for modifications based upon manager inputs 30. The manager's computing device 6 also incudes a wireless connection 32 to the internet. This allows finalized results based upon the manager's inputs to be sent out and received by the end user 10 client at the client's computing device.

The compiled results of the agent computing device 4 software application 16 is placed in a uniform way so that all such data received by the manager computing device 6 is in the same readable format. In the prior art, each agent may have a different way of organizing and compiling results, which can take the manager more time to sift through. The present invention provides a uniform, adaptable, and adjustable format to fit all financial planning service needs.

A central computing database 34 containing a CPU and data storage 36, questionnaire database 38, and network connection 40 allows additional questions and data collection requests to be fed directly to the agent's computing device 4 through the wireless network 8 in real time as questions are answered and additional information is gathered based upon those answers.

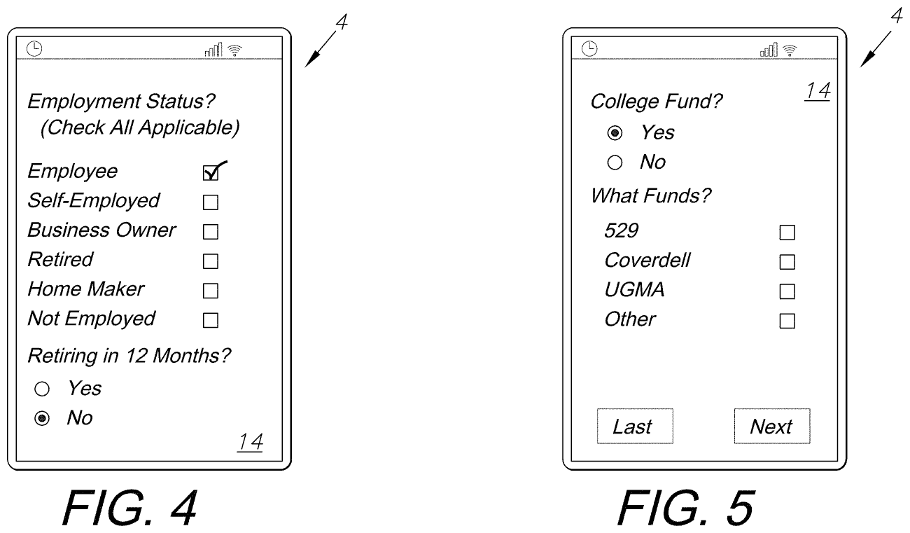

FIGS. 4 and 5 show example user interfaces (UI) 14 and aspects associated with a software application stored on a field financial expert's mobile computing device 4. These UI provide examples of some of the data requests that the client is asked to fill out while using the software application. All data input into the software application is received, stored, and analyzed at a remote location by a central computer server 34.

While interacting with the software application 16, the UI 14 presents a list of alerts which are generated by a central computer server based upon the data input by the client. These alerts indicate points of potential discussion between the financial planning expert and the client. These alerts are not a call for action or even a suggestion to take action or withhold action in any way. They are meant to be items that may be of interest to explore over a meaningful conversation with their financial professional. Any action or inaction will come as a result of having spoken further about the potential merits of each to see if they may be applicable to that individual or family.

Some examples of these questions and related alerts are as follows:

Question: Have you considered looking at filing as ‘Head of Household’ (if single) or ‘Married filing Jointly’ instead of ‘Married Filing Separately’? If changing your filing status could save you some significant money you would want to do that correct? Resulting Alert: Tax filing status e.g. “Head of Household” designation. This alert will only trigger if they have stated that they are filing as a single filer, have a dependent living with them and pay over 50% of the household expenses.

Question: How much was your refund last year? Is that normal? Is that intentional? (if ‘yes’ to intentional) Obviously you enjoy getting the large lump sum, what do you do with it every year? If you could get that money right now by adjusting your withholdings and use it more efficiently to reduce your debt and increase your retirement, would you do it? Resulting Alert: Tax Refund (e.g. $4,000+ refund). This alert will only trigger if they are receiving a tax refund of more than $4,000 from the Federal government

Question: Burning through all of our retirement money too soon is a big concern for everyone, agreed? Do you have an exact plan to maximize your cash flow and make sure you don't run out of money? Would you like to know how to do that? Are you retiring in the next two years? Resulting Alert: Retirement planning options e.g. moving retirement fund to an IRA. This alert will only trigger if they answered that they are planning on retiring in the next two years

Question: Would you like to help with your kid's college? Resulting Alert—Educational Savings Account to trigger if they do not currently have a 529, Coverdell, or UGMA account. This alert will only trigger if they don not currently have a 529, Coverdell or UGMA account and they have children at home under the age of 18.

Simple question, do you want to decide who raises your kids or have a judge do it? If we can help you get a will easily and inexpensively would you want to do that? Resulting Alert: Will. This question/alert will only occur, for example, if the client indicates they do not have a will.

Other potential questions and alerts include all facets of family financial planning, education savings, insurance, retirement, etc.

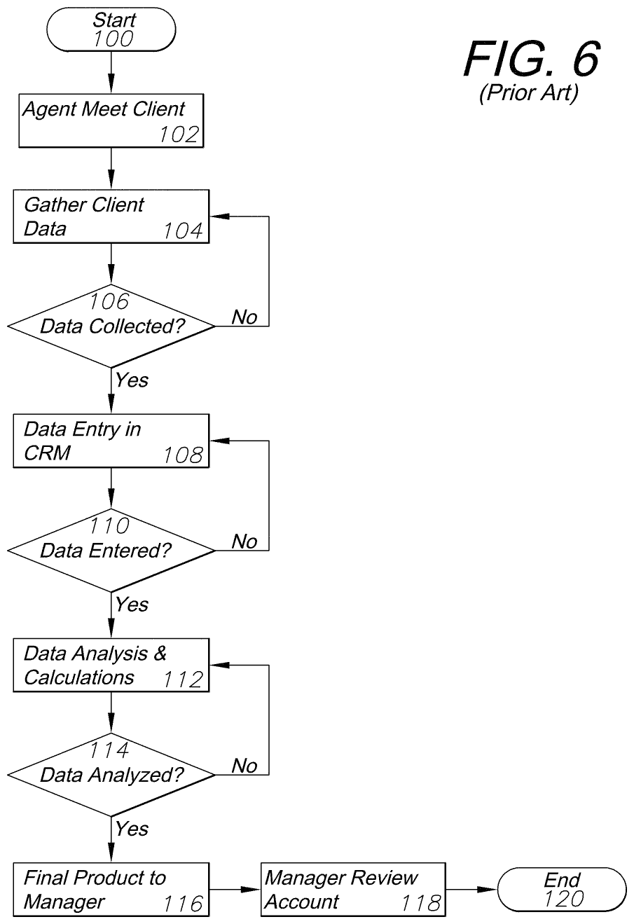

FIG. 6 diagrams a prior art method of practicing a financial planning system. That typical process begins at 100, where an agent and a client meet in person or remotely at 102. In most situations, this meeting is in person. The agent will ask the client questions, resulting in gathering client data at 104. This process continues until all relevant data is gathered at 106, at which point the agent and the client will separate and the agent will begin entering the collected data into CRM at 108.

The data is entered until all data is entered at 110. Once all data is entered, the data is then analyzed by the agent at 112 with calculations being performed as necessary. Once all data has been analyzed at 114, then the data can be packed into a final product and sent to the manager at 116. This is all a time-consuming process for the agent who cannot meet with other clients during this process.

The manager reviews the account at 118 and the process ends at 120 from there.

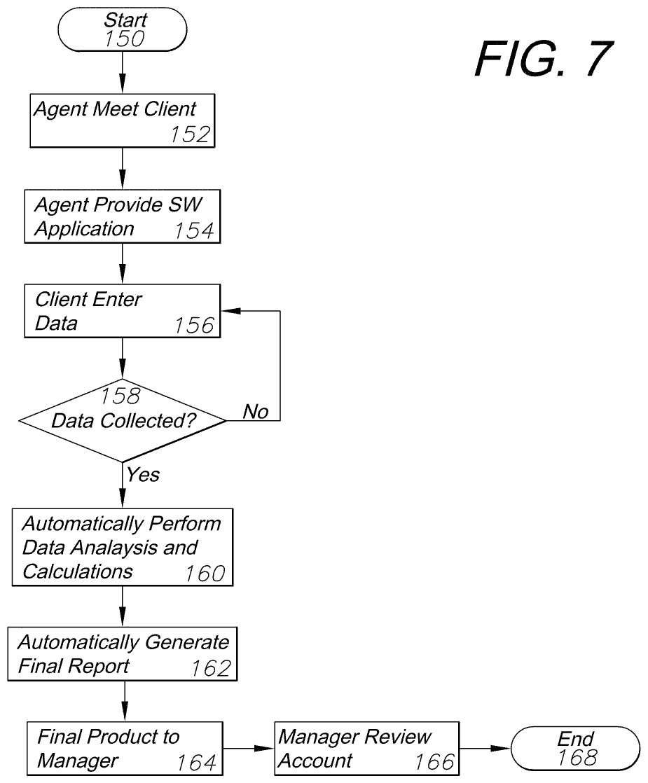

In contrast, FIG. 7 shows the steps taken during the practice of the present invention which includes fewer steps and fewer areas for agent mistakes or client input to cause errors in the data collection. The process begins at 150, and like before the agent meets with the client at 152. In the present invention, rather than the agent asking the questions to the client, the agent hands their computing device to the client and allows the client to input data directly into the software application at 154. This prevents errors in communication between the client and the agent, and the agent is available if the client has any questions about the questionnaire forms.

The client enters their data at 156, and as questions are answered additional questions may be pulled from the central computer database or from the manager directly through the manager's computing device. This continues until all data is gathered at 158, after which the system will automatically perform the necessary data analysis and calculations at 160 and form a final, uniform report at 162 which is sent to the manager at 164 for final review at 166 and the process ends at 164. The automatic data analysis and calculations performed by the system frees the agent up to meet with additional clients or to perform additional work.

The present invention is more than merely a financial planning tool, however. Putting the power of inputting the client's data in the client's own hands allows the process to move quickly, without unnecessary discussion of options that may be irrelevant or redundant to the client. This also provides an ideal training tool for the financial planning expert, as the software application will guide them through talking points and options that they may not even be aware of yet. Finally, all of this data is saved anonymously, such that the financial planning expert's manager can discuss individual results with the expert at a later time for potentially revisiting the client with other financial planning options.

Through use of this communication software application, the client and expert receive immediate feedback and training from the supervisor to the field rep within 24 hours. In just a few minutes review the supervisor will know what was discussed and be able to train that rep on how best to help the client moving forward. Classroom training in all fields is inferior to what one may learn while actually practicing their trade. There is no personal information from the client that ties this data to them other than their initials. The data will be time stamped when it is gathered and the initials will allow the agent to recall who they were meeting with at that time to facilitate their training.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A financial planning and analysis system comprising:
a first computing device comprising a processor, data storage, user interface, and first software application comprising a plurality of queries from a first set of queries answerable via said user interface;
said first software application further configured to prompt at least one query from a second set of queries answerable via said user interface, said at least one query form said second set of queries being prompted based upon a response to one of said plurality of queries from said first set of queries;
said first computing device configured to store responses generated from inputs into said user interface answering said plurality of queries form said first set of queries and said at least one query from said second set of queries;
said first computing device configured to gather and transmit responses to said plurality of queries form said first set of queries and said at least one query from said second set of queries to a second computing device;
said first computing device further configured to automatically analyze said responses on said user interface and to generate a preliminary report therefrom;
said user interface configured to display said preliminary report;
said first computing device configured to transmit said preliminary report and said responses to a second computing device located remotely from said first computing device, said second computing device comprising a processor, data storage, user interface, and second software application configured to generate a final report; and
said final report being generated from said preliminary report, said responses, and manager inputs which are input into said second software application via said second computing device.

2. The system of claim 1, wherein said user interface of said first computing device comprises a touch-screen interface.

3. The system of claim 1, further comprising:
said client inputs configured to represent client financial information; and
said final report comprising a financial plan associated with a specific client.

4. The system of claim 1, further comprising:
said responses being associated with a first client;
said first computing device configured to receive inputs from a second client and thereby generate responses associated with said second client;
wherein said responses associated with said first client and said responses associated with said second client are unique; and
wherein said preliminary report considers said responses of said second client anonymously.

5. The system of claim 1, further comprising:
said responses being associated with a first client;
said first computing device configured to receive inputs from a plurality of additional clients and thereby generate responses associated with each respective one of said plurality of additional clients;
wherein said responses associated with said first client and said responses associated with each respective one of said plurality of additional clients are unique; and
wherein said preliminary report considers said responses of each respective one of said plurality of additional clients anonymously.
